(19) United States
(12) Patent Application Publication
(10) Pub. No.: US 2012/0163266 A1
(43) Pub. Date: Jun. 28, 2012

(54) GLOBAL PUSH-TO-COMMUNICATE APPLICATION AND SYSTEM

(76) Inventors: Ryan Scott Rodkey, Sugar Land, TX (US); John Frank Rodkey, JR., Missouri City, TX (US); Darren Lynn Ross, Sugar Land, TX (US); Nicholas R. Davis, League City, TX (US); Jacob M. Haggerty, Stafford, TX (US); David Lynn Hickey, Rosharon, TX (US)

(21) Appl. No.: 12/980,126

(22) Filed: Dec. 28, 2010

(51) Int. Cl. H04W 4/10; H04H 20/71

(52) U.S. Cl. 370/312; 455/518

(57) ABSTRACT

A global push-to-communicate system supports communication between any two or more devices with one another by a simple push-to-activate operation. Users create and send text, voice and graphic messages to other users on the system anywhere in the world where data transmission via the Internet or other networks is available. The application may be installed on any digital communication device and permits multiple format messages to be reconfigured into a data stream so that the multiple components may be sent in a single message packet. This includes a cell phone, personal digital assistant (pda), computer, television, radio, interactive displays and the like. All messages are digitized and sent over the network. Voice, text, video, still images, graphics, gps data, mapping and other message components, in any combination, may be sent in a single transmission.

### BACKGROUND OF THE INVENTION

1. Field of the Invention

The invention is related to two-way communication devices and is specifically directed to a multiple channel, global two-way communication system application for any digital transmitter/receiver.

2. Discussion of the Prior Art

Two way communication devices have been around for many years. The devices most closely related to the subject invention are commonly referred to being in the “walkie-talkie” class. Specifically, this class of devices permits one or more transmitting persons to speak to a remote receiver person or group of persons over a wireless communication channel by simply activating his device and beginning transmission. The receiver's device is automatically activated to receive the transmission in near real time as it is being transmitted.

The walkie-talkie device is typically a hand-held, portable, two-way radio transceiver. Major characteristics include a half-duplex channel (only one radio transmits at a time, though any number can listen) and a “push-to-talk” (P.T.T) switch that starts transmission. Typical walkie-talkies resemble a telephone handset, possibly slightly larger but still a single unit, with an antenna sticking out of the top. Where a phone's earpiece is only loud enough to be heard by the user, a walkie-talkie's built-in speaker can be heard by the user and those in the user's immediate vicinity. Hand-held transceivers may be used to communicate between each other, or to vehicle-mounted or base stations.

An early walkie-talkie type radio receiver/transmitter was the Motorola SCR-300, developed in the early 1940s to support the war effort. In the mid-1970s the Marine Corps initiated an effort to develop a squad radio. The AN/PRC-68 was first produced in 1976 by Magnavox, was issued to the Marines in the 1980s, and was adopted by the US Army as well. More recently cellular telephone networks offer a push-to-talk handset that allows walkie-talkie-like operation over the cellular network, without dialing a call each time. Walkie-talkies are widely used in any setting where portable radio communications are necessary, including business, public safety, military, outdoor recreation, and the like.

Typically, walkie-talkie type land mobile radios are dependent on local network towers and signal amplifiers to transmit the signal beyond the limited range (often two miles or so) capable of a fully integrated device. This makes this type of transmission limited in rural areas or areas where system support is not available. The cellular “push-to-talk” technology is also limited to those areas where system support is available. In addition, walkie-talkie and push-to-talk technologies are limited to voice/audio transmission only.

### SUMMARY OF THE INVENTION

The subject invention is directed to an application for a communication device and permits multiple format messages to be reconfigured into a data stream so that the multiple components may be sent in a single message stream. All messages are digitized and sent over a data network, eliminating the need for cellular network connectivity. Voice, text, video, still images, graphics, gps data, mapping and other message components may be sent in a single transmission. The application is installed on any communication device that has data connectivity. This includes a cell phone, personal digital assistant (pda), tablet PC, computer, television, radio, interactive displays, land mobile radios, and the like.

The subject invention is directed to a global push-to-communicate system, wherein any two or more devices having the application of the invention installed and connectivity to the Internet or secured LAN or WAN network may communicate with one another by a simple push-to-activate operation. Specifically, the application of the present invention will allow users to create and send text, voice and graphic messages to other users on the system anywhere in the world where data transmission via the Internet or secured data network is available.

Specifically, the communication system of the subject invention is operable anywhere a data transmission signal is available and operates in a “cloud” environment not dependent on any specific service provider for transmission support.

The message may be created and sent, or may be created as being sent. The message may be a simple near real-time voice message, or may be bundled with any combination of voice, text, graphics, video, still image and gps information. The application is not service dependent in contrast to many available walkie-talkie applications, but is compatible with any other device which has connectivity to the Internet and has a compatible application installed. The application is particularly robust in that it permits the simultaneous transmission of multiple media data, unlike most walkie-talkie or “push-to-talk” applications. In addition, like “push-to-talk” applications, two way communication can be undertaken once the application is activated by the sender of the message.

One important feature of the invention is that the sender and recipient(s) can communicate with one another using a simple “push-to-talk” functionality. Specifically, it is anticipated that unless the application is selectively turned off by a recipient, once the sender initiates transmission it will be automatically received and displayed or played at the recipient(s) device. A data packet will be received, in near real-time, as it is transmitted. Attachments may also be displayed in near real-time, or stored for recall, as desired. In the event the recipient device is deactivated, the transmitted data may be stored as cache. Voice-to-text and text-to-voice technologies currently available may be utilized to store the message in any desired format.

In its broadest sense, the subject invention is a server centric two-way communication network using an internal processor with data storage for containing computer instructions for instructing the processor to perform a series of steps. The server is in communication with the internal processor for housing a create communication channel module, a distribute communication channel module and for accessing a communication channel. The database associated with the process also includes user device information, user authority and permissions, data which has been or is ready to be transmitted, and where desired, reporting formation. The system application associated with the processor provides for preparing the communication(s) channel module, the distribution communication channel module, and the data transmission module. The application may communicate with the processor instructing the server to prepare at least one communication channel, and upon receiving the instructions from the processor the server may create a communication channel using the communication channel module, and upon creating the communication channel the server may distribute the communication channel through the processor using the communication channel module, and upon distributing the communication channel the application may transmit data using the data transmission module to the communication channel. The data may include, for example, any combination of a voice message, a text message, still images, video, mapping information and graphics, attachments and a gps signal. The data is bundled into a packetized data signal which may be transmitted over any data network.

### BRIEF DESCRIPTION OF THE DRAWINGS

FIG. 1 is an illustration of the application icon as presented on a cell phone, PDA screen or other handheld or portable device.

FIG. 2 is an illustration of the application icon as presented on a computer screen.

FIG. 3 is an illustration of the application icon as presented on a typical television viewing screen.

FIG. 4 is a basic flow chart illustrating the basic flow of information when using the application of the present invention.

FIG. 5 is a basic flow chart of the application system.

FIG. 6 is a diagram of the system architecture.

FIG. 7 is an illustration of the cloud-to-device messaging using the application of the subject invention as a “push” to Google's C2DM (Cloud-to-Device-Messaging) application or similar commercially available application.

FIG. 8 is a detailed illustration of the icon shown in FIGS. 1, 2 and 3.

FIG. 9 is a screen shot showing the first screen to appear when the application of the present invention is activated by clicking or pressing the icon of FIG. 8.

FIG. 10 is the screen shot which appears after selecting one of the options shown in the screen of FIG. 9.

FIG. 11 is an example of an incident tracking and alert screen which appears when the “Create Incident” option is selected in the screen of FIG. 9.

FIG. 12 is an example of a messaging screen which appears when the “Radio” option is selected in FIG. 9.

FIG. 13 is an example of an emulator grouping option which is available when the “Emulator” option is selected in and activated.

FIG. 14 is an example of the channel selection features available.

FIG. 15 illustrates channel control options dependent upon user authority.

FIG. 16 is an example showing language selection capability using sub-channel selectivity when selecting a channel as shown in FIG. 14.

FIG. 17 is an example of the option to select additional servers.

### DETAILED DESCRIPTION

The subject invention is directed to a global push-to-communicate system, wherein any two or more devices having the application of the invention installed and connectivity to a network may communicate with one another by a simple push-to-activate operation. Specifically, the application of the present invention will allow users to create and send text, voice and graphic messages to other users on the system anywhere in the world where data transmission via a network is available.

The application is capable of leveraging commercially available commercially available technologies, such as, by way of example, smart phones and other pda's to permit:

1. Video capture and send
2. Live video stream
3. Sender's GPS location
4. Two way (or multiple participant) voice transmission
5. “Push” notification to multiple recipients or groups
6. Voice messaging

In essence, the invention permits the use of “smart devices” to send a message to a recipient in near real-time using a single “push-to-communicate” feature. The message may be created and sent, or may be created as being sent. The message may be a simple near real-time voice message, text, graphics, video, still images, and gps information, or may be bundled with any combination. The application is not service dependent in contrast to many available walkie-talkie applications, but is compatible with any other device which has connectivity to a network and has a compatible application installed. The application is particularly robust in that it permits the simultaneous transmission of multiple media data, unlike most walkie-talkie or “push-to-talk” applications. In addition, like “push-to-talk” applications, two way communication can be undertaken once the application is activated by the sender of the message.

Because the application is not device dependent, it can be utilized with both wired and wireless communication apparatus, including, but not limited to smart phones, pda's, cell phones, tablets, game consoles, computers, televisions, radios, interactive displays and basically any device having internet connectivity. Secure servers may be used for transmitting over secure channels, and unsecure channels may be used for social or non-critical communications. Messages may be encrypted and users' may be required to be authenticated or password protected. Different levels of users may be established, with rights dependent on user level, active user invitation, administrative user designation, or priority. Highest priority may, for example, block all other communications. The application is designed to be downloaded from the server to any device, i.e., requested from the server to the device. An authorization code and or user registration may be used to control downloads. Since all messages pass through a central server, messages may be audited and reports may be generated. All messages, regardless of format, are reconfigured into a single compatible data stream, permitting voice, text, video, images, and graphics to be sent in a single message, and reconfigured upon receipt into numerous formats. Messages may be private, to small groups, or broadcast over a large area, by selecting recipients, a specific group or channel, or merging multiple groups or channels.

A particularly significant use of the application is to permit first responders to react quickly in reporting an incident, responding to and locating and incident, providing detailed information and providing accurate, automatic location coordinates. This not only replaces radio and other contemporary communication devices and computer systems, but is also faster, more robust and more dependable than cellular networks by relying solely on Internet connectivity for transmission and reception. The application is designed to be used as a fully self-contained application for any operating system, mobile operating system, network platforms and is compatible with smart devices including but not limited to; smart phones, pda's, televisions, visual displays, tablets and computer systems.

The application will permit both encrypted and unencrypted messages to be sent. The transmissions may be password protected where desired. Individuals or groups may be recipients at the discretion of the sender. Public groups may be contacted, as well as private groups or individuals controlled at the device. Public groups and controlled groups may be maintained at a remote server. The system supports voice-to-text, text-to-voice, language translation capability and similar features using known technology.

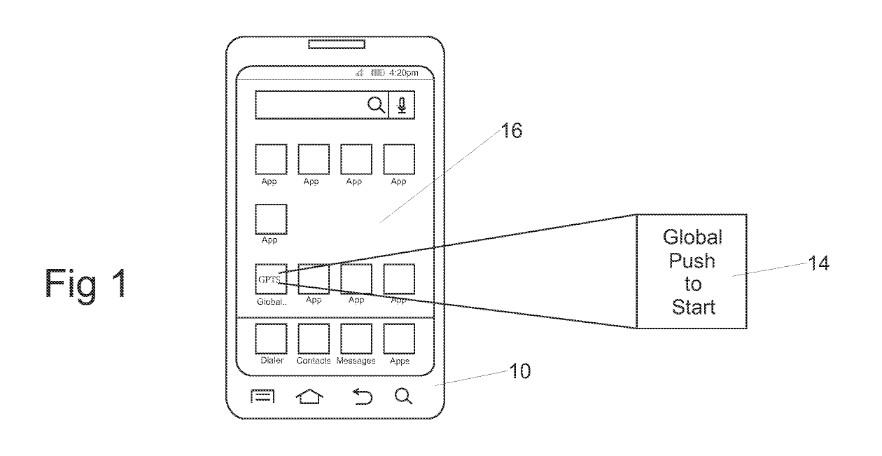

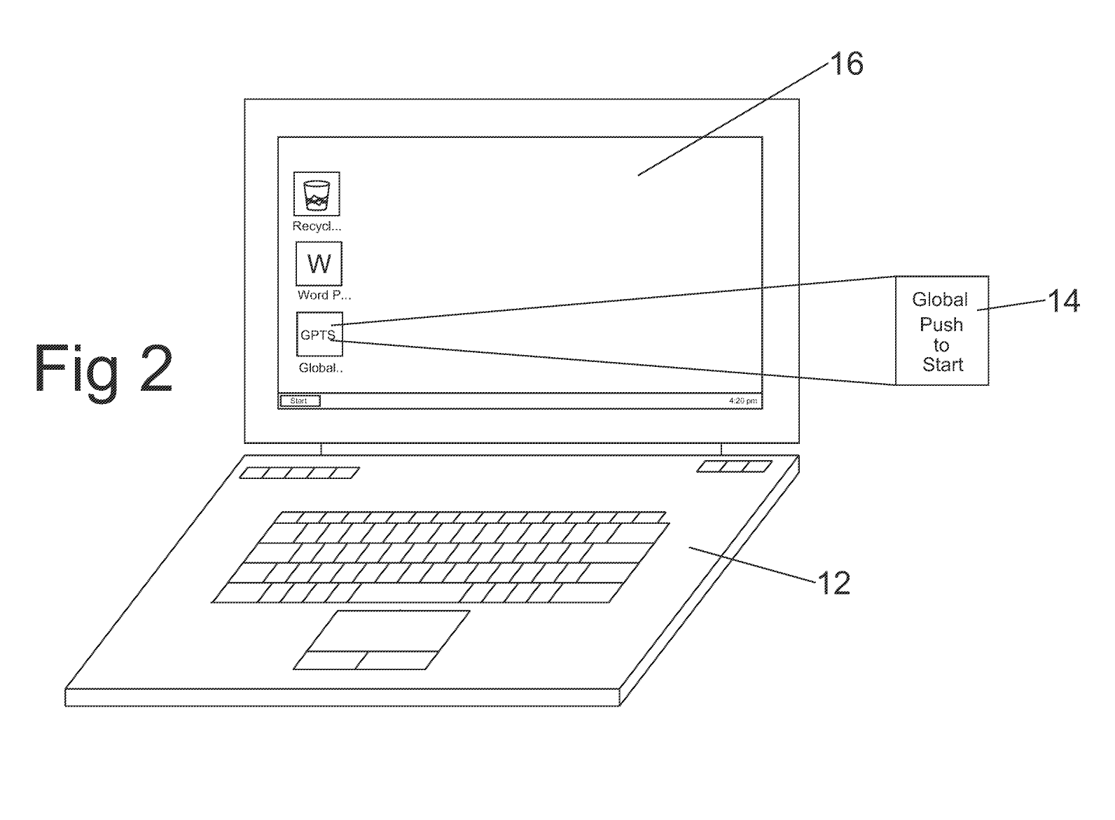

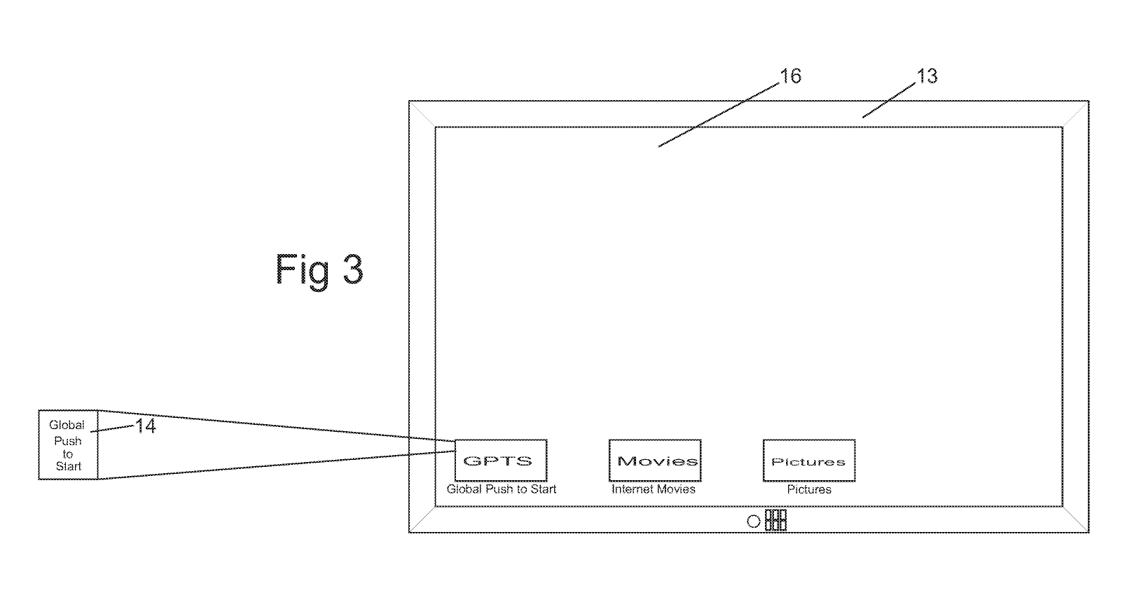

With specific reference to FIGS. 1, 2 and 3, in practice, the sender will create a message “bundle” or packet at the sending device. The sending device may be a smart phone or other pda 10 as shown in FIG. 1 or a computer 12 as shown in FIG. 2, or even a conventional digital television 13 as shown in FIG. 3. This message bundle may include a video clip or a still shot of an incident and other information which may be stored on the device, which is then automatically attached to the message when the application icon 14 is selected on the display screen 16. Where desired, the message may be a real-time voice message which would not require any pre-selection bundling before the application is activated. However, by way of example, a recorded message may be selected to be sent, either with or without a real-time voice message. In addition, it may be desirable to attach a still image or streaming video to the message. The application is also adapted to attach and send GPS coordinates when so enabled. It is also possible to add recorded messages, live still shots and live streaming video during the transmission of the message.

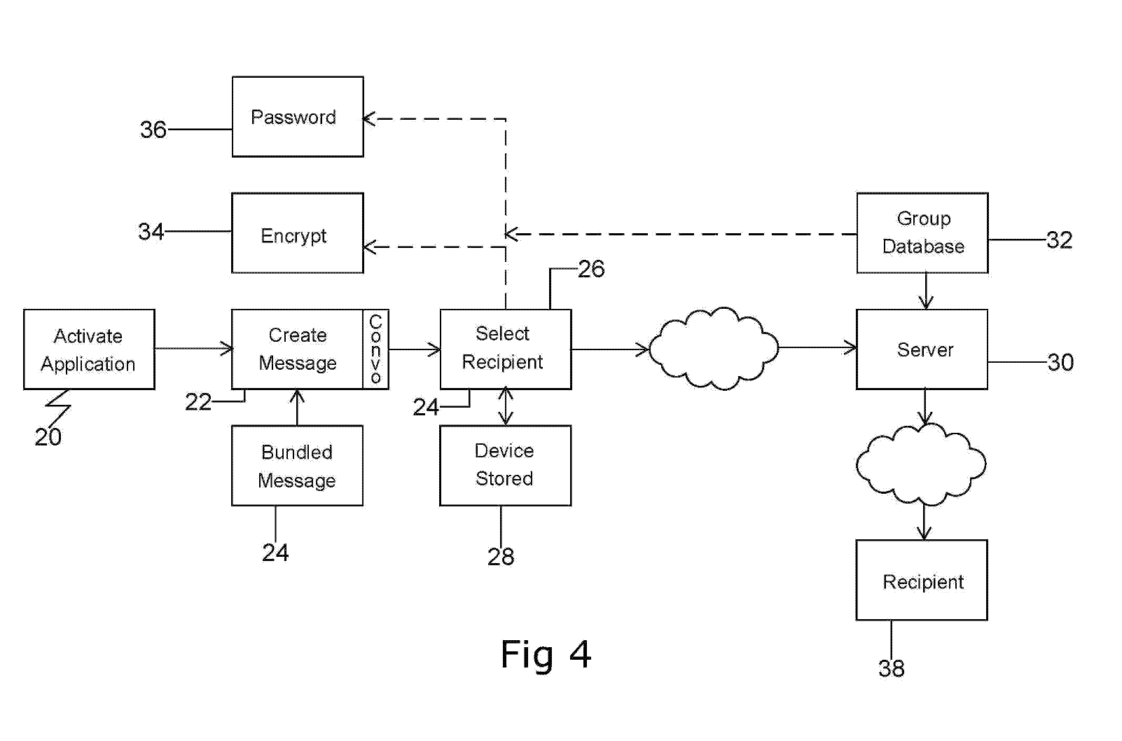

Once the “bundled” message is created, the application converts the message to a data stream capable of being sent over a network. The message is then transmitted to a server for distribution. As illustrated in the flow chart of FIG. 4, once the application is activated by activating the icon 14, as illustrated at block 20, the system is active to permit the sender to create a live message as indicated at 22. If the sender has created an attachment such as a still, video, or graphic illustration, as well as pre-entered text and/or a pre-recorded voice message, this is bundled and attached to the system as part of the created message, as shown at block 24. This bundled message may also include GPS coordinates which may be generated at the device, as well as map graphics when such are stored at the device.

In its preferred form, the subject invention is a server based (see server 30) two-way communication network using an internal processor (not shown) with data storage 32 for containing computer instructions for instructing the processor to perform a series of steps. The server 30 is in communication with the internal processor for housing a create communication channel module, a distribute communication channel module and for accessing a communication channel. The database associated with the process also includes user device information, user authority and permissions, data which has been or is ready to be transmitted, and where desired, reporting formation. The system application associated with the processor provides for preparing the communication(s) channel module, the distribution communication channel module, and the data transmission module. The application may communicate with the processor instructing the server to prepare at least one communication channel, and upon receiving the instructions from the processor the server may create a communication channel using the communication channel module, and upon creating the communication channel the server may distribute the communication channel through the processor using the communication channel module, and upon distributing the communication channel the application may transmit data using the data transmission module to the communication channel. The data may include, for example, any combination of a voice message, a text message, still images, video, mapping information and graphics, attachments and a gps signal. The data is bundled into a packetized data signal which may be transmitted over any data network.\

The created message may also include a live component which may include live voice, live video and live stills. All of the message components are created using presently available technology, as will be understood by those who are of ordinary skill in the art. For example, “smart phones” permit the capture of voice, text, stills and video, and the attachment of stored information such as graphic illustrations, mapping, and the generation of GPS coordinates. The application of the subject invention is designed to capture any combination of these components and create a bundled message which may be sent as a data stream.

Once the message is created, it is converted to a data stream as indicated at block 24. The sender then selects the recipient(s), as indicated at block 26. This can be accomplished automatically, if the recipients are pre-programmed, or may be manually selected. Private or sender controlled recipients may be stored on the device as indicated at block 28. It may also be desirable to store the recipient(s) contact information in a database 32 at a remote server 30. The server may be a system supplier, or may be a closed system controlled by the user network. For example, city first responder systems may be semi-public systems available to all persons having an application, whereas military applications may be controlled systems using encryption techniques and secured networks.

Where desired, the message may be encrypted or password protected at this stage, as indicated at blocks 34 and 36. Typically, the selection of the recipient(s) automatically will determine whether this is a required function.

Once the recipient selection is made, the data stream signal is sent to the remote server 30 for distribution. The finalized, bundled message is then sent to recipient(s) having the application of the subject invention installed on their own devices.

One important feature of the invention is that the sender and recipient(s) can communicate with one another using a simple “push-to-talk” functionality. Specifically, it is anticipated that unless the application is selectively turned off by a recipient, once the sender initiates transmission it will be automatically received at the recipient(s) device. A voice message will be received, in near real-time, as it is transmitted. Attachments may also be displayed in near real-time, or stored for recall, as desired. In the event the recipient device is deactivated, the message will be stored as a cache. Voice-to-text and text-to-voice technologies currently available may be utilized to store the message in any desired format.

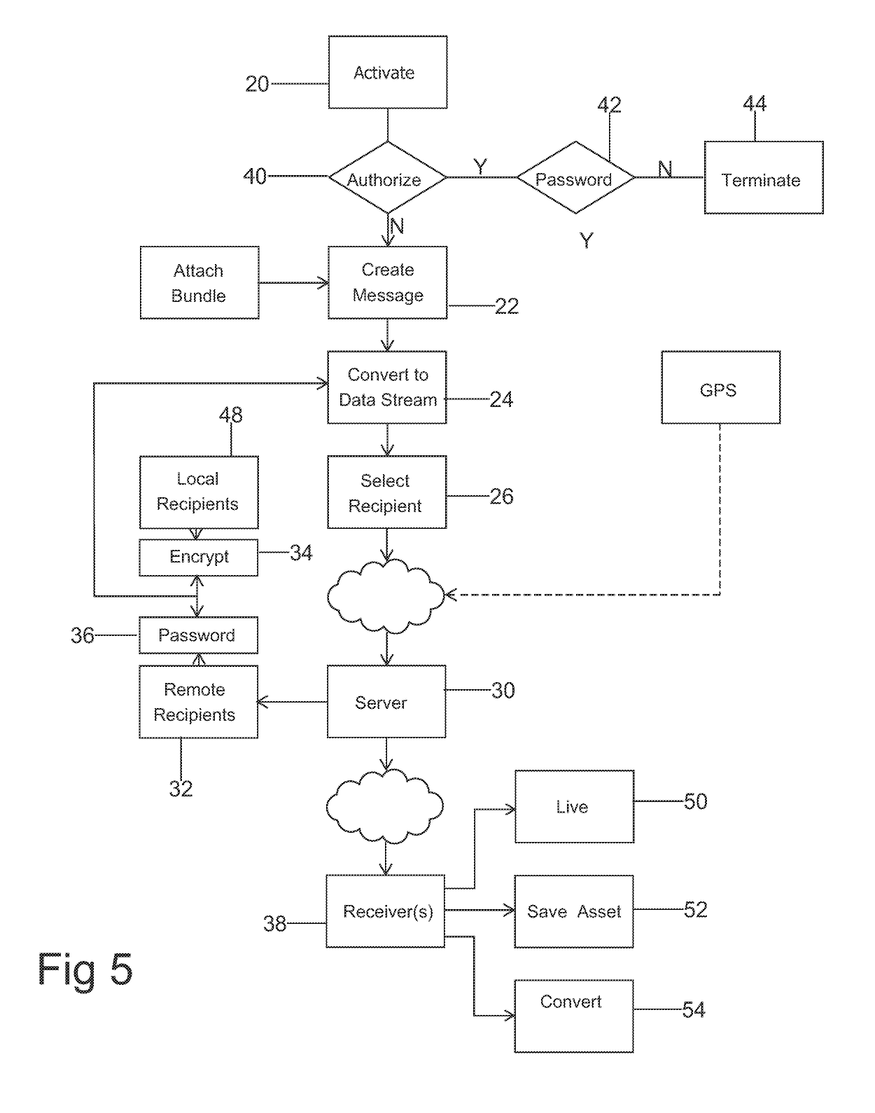

A detailed flow diagram is provided in FIG. 5. As there shown, once the application is activated at 20, it may be desirable to confirm the sender's authority as indicated at 20. At this time, the GPS signal showing location of the sending device will also begin transmission, as indicated at 21.

The authorization function may be controlled by a password or other identifier. If password protected, a correct password will be indicated at 42 and the sender will be authorized to create a message at 22. If an incorrect password is entered the application will terminate the transmission as indicated at 44. If the application is not password protected for the specific transmission, the authorization step will be bypassed. It is anticipated that certain messages, such as incident alerts would be password protected while others, such as social networking, would not be so protected. Thus, the authorization requirement may be dependent upon the type of message to be sent.

Once authorized (if required), the sender may create a real-time message as indicated at 22, and attach any pre-captured bundle, as indicated at 46. The bundle may also be created in real-time, such as, by way of example, streaming video or live stills.

The comprehensive message is then converted to a single data stream at 24, and the sender selects the recipient(s) as indicated at 26. Local or private recipients may be stored on the device, as indicated at 48, or may remotely stored at a remote server as indicated at 32. The remote server may also store recipients of various categories such as, by way of example, first responders, controlled subscribers, approved groups and the like. Once the recipients are selected, the identity of the recipients will determine whether the message is to be encrypted, as indicated at 34, or password protected as indicated at 36, or both. In the event protection is required, this will be embedded in the message as it is created at 24.

Once the message data stream is completed, it is transmitted via the network to a remote server 30 for distribution to selected recipients as indicated at 38. It may be received as a live, near real-time message as indicated at 50, or saved as sent as indicated at 52, or converted to various receiver controlled formats as indicated at 54, or any combination thereof.

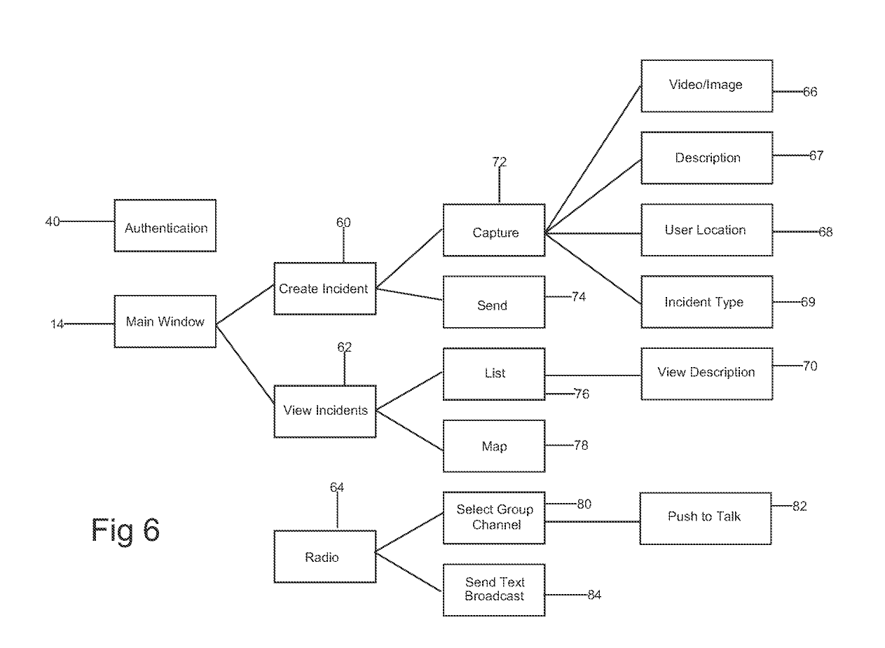

The basic architecture of the application system is shown in FIG. 6. As there shown, the activation step is provided in the main window 14, which is synonymous with the icon 14 shown in FIGS. 1, 2 and 3. As previously discussed with respect to FIG. 5, the authentication or authorization step 40 follows, where required. Once authorized (when required) the sender then is presented with a window which permits him to select the type of message to be created and sent. By way of example, this can be the creation of a message relating to an incident, as indicated at 60, the viewing of an incident, as indicated at 62, or a radio transmission (typically, initiation of a two-way voice communication) as indicated at 64. Various message components may be either created or collected from a store, as indicated at 66, 67, 68, and 69. This includes, but is not limited to video/still image 66, text description 67, user or device gps location 68, incident type (fire, accident, chemical spill, etc.) 69, or any combination. These message components are captured as indicated at 72 and sent as indicated at 74.

One feature of the application is the ability to view incidents as they unfold, as indicated at 62. The incidents may be listed 76, with a view and description as indicated at 70, and a map of the area or location of the incident may be generated at 78 using known mapping technology and gps coordinates.

A significant operation of the application is the push-to-send capability at both ends of a communication using the digital radio feature 64. This permits any party in the selected group or channel 80 to simply push-to-talk as indicated at 82. As previously described, in typical applications once the sender activates the system it is automatically activated at all recipient devices unless voluntarily disabled by the recipient. Thus, once activated, all parties have an active push-to-talk function. Text broadcasts may also be sent as indicated at 84.

The create incident, view incident and radio functions may be used separately or in any combination to provide comprehensive communication capability. An important feature of the invention is that all of the message components are packaged or bundled in a data stream which may be sent over the network, without any dependency on a cellular network provider. The application is functional anywhere a data transmission signal is present.

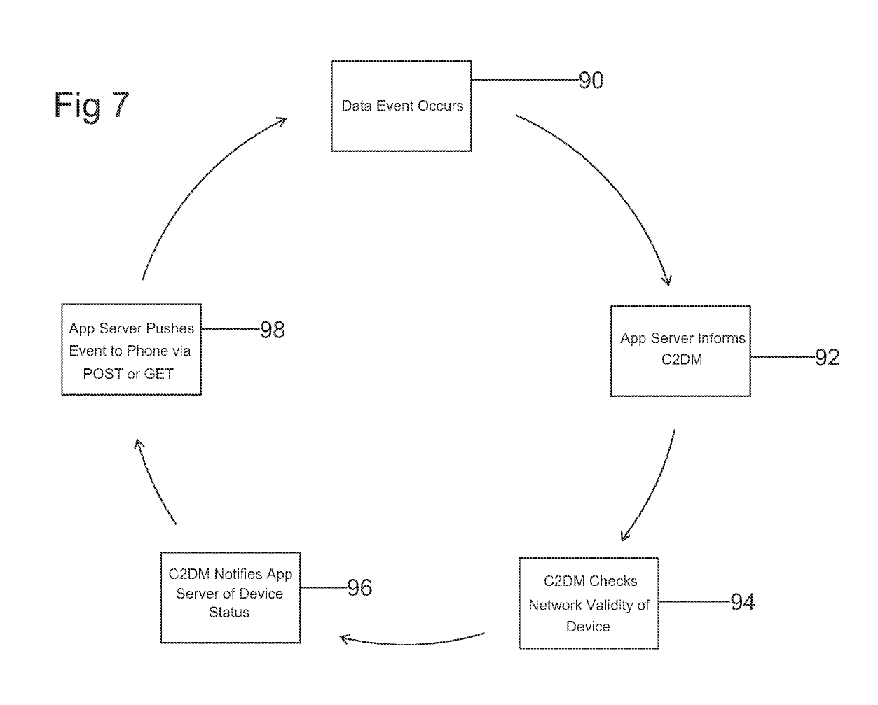

An important feature of the invention is the ability to use available technological components to push or send a message from currently available devices over the network in a digital data stream format. An exemplary message “push” using the Google C2DM (Cloud-to-Device Messaging) System is shown in FIG. 7. As there indicated, the system is initiated when a data event occurs. This sends the message to the C2DM server 92. The C2DM sever then checks validity, and after confirmation, notifies the application server 92 of device status as indicated at 96. The application server then pushes the event message to a phone or other recipient device via POST or GET as indicated at 98.

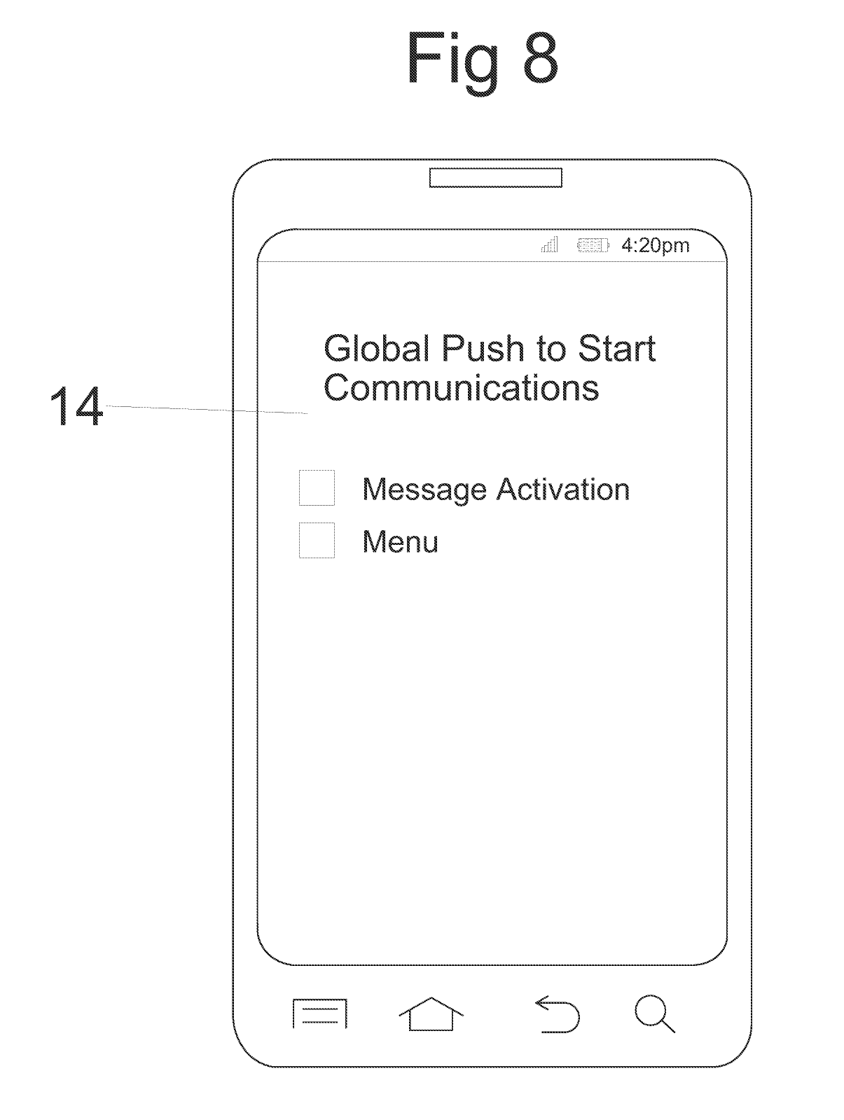

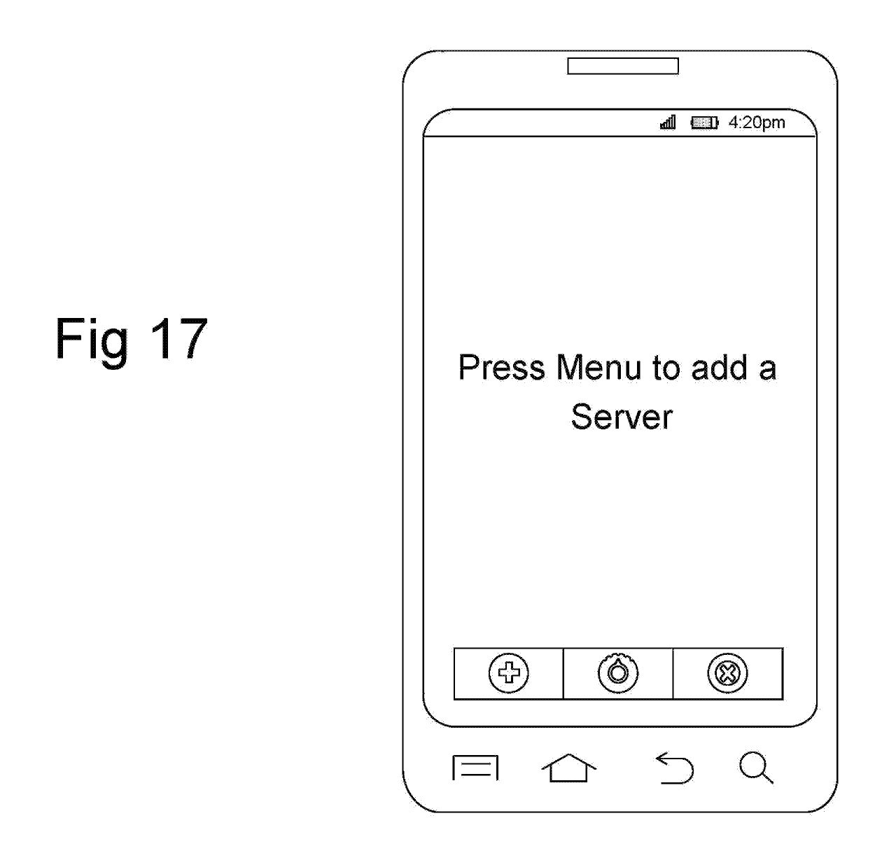

FIGS. 8-17 illustrate the various windows which are presented to a sender/user in an exemplary system. FIG. 8 is an illustration of the main window or application icon 14. This would be present on the main screen or desktop. While this screen may include several options, it is typically used to initiate the messaging function as indicated at 15. A more comprehensive menu, see 17, may also be included. This would be for administrative functions for those users with proper, authenticated authority. One example of an administrative function may be the selection of servers, as discussed with respect to FIG. 17.

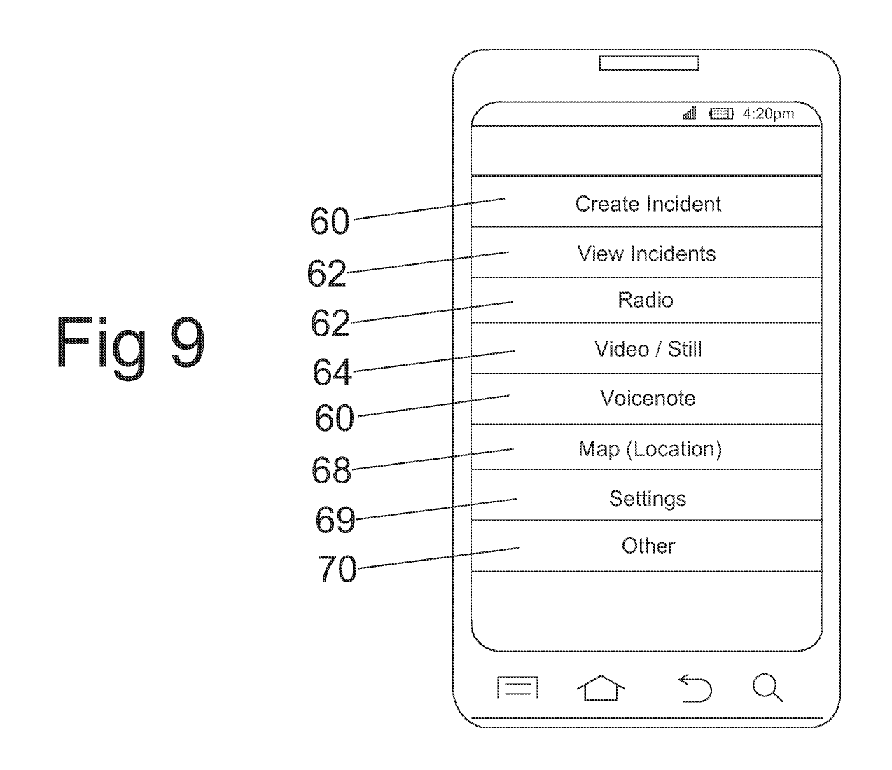

Typically, once the original icon 14 is selected, the system will either default to the messaging function, or the user will select it by selecting the Message Activation function 15. Once pressed or clicked to activate, the next window, FIG. 9, shows the options available to the user. This includes “Create Incident” 60, “View Incident” 62, “Radio” 64, as shown and discussed with respect to FIG. 7, and may include additional options such as “Voice/Still” 66, “Voice Note” 67, “Map” 68, “Settings” 69, or other options as indicated at 70. Any combination of these features may be selected.

Specifically, this screen permits the sender to select the type of message he is going to send once the system has been activated. For example, if he is simply going to send a voice message, he would select the global icon 14 which would activate the screen shown in FIG. 9. He would then select the “Radio” option 64.

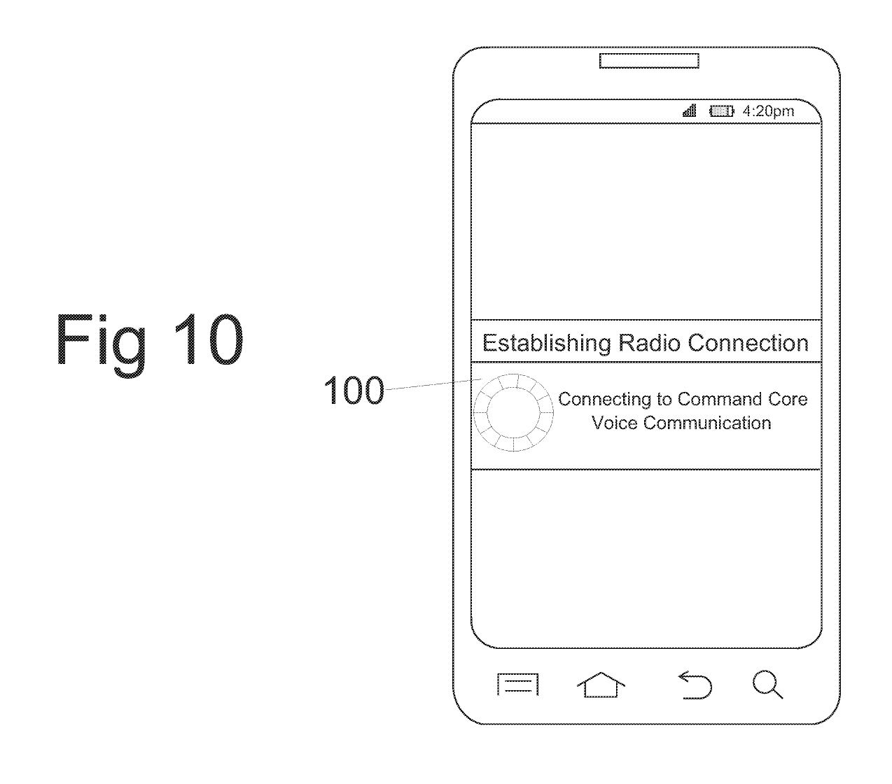

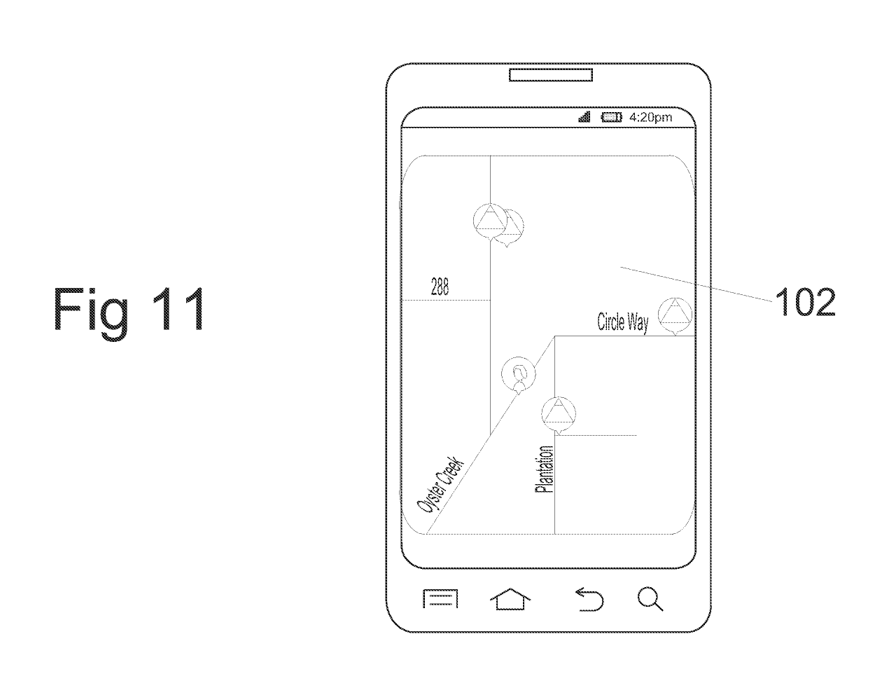

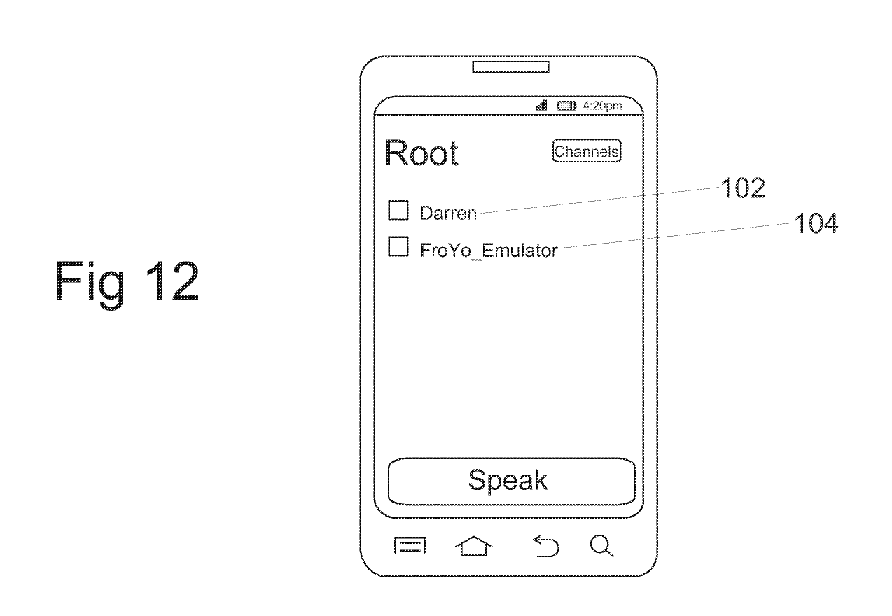

Once the option(s) is selected, a connection is established via a digital transmission channel and this is displayed as a new window 100, as indicated in FIG. 10. In this example, it is indicated that a Radio Connection is being established. If the message was going to include other content in addition to the voice transmission, the user would be prompted to begin a broadcast stream or load attachments such as videos, stills, or a location map prior to establishing the radio connection. Once the message is finalized and may include visual data, such as the incident map 102, shown as a window in FIG. 11, when the “Map View” 104 is selected, the sender selects the recipients, see FIG. 12 and the completed message is sent. As shown in FIG. 12, the recipients may be a single person “Darren” 102 or a pre-defined group 104: At this point the “Speak” function is activated, by selecting “Speak” 106, and the message is transmitted. In a simple radio transmission to a controlled group of recipients the selection steps may be omitted and the system will operate in a typical push-to-communicate manner.

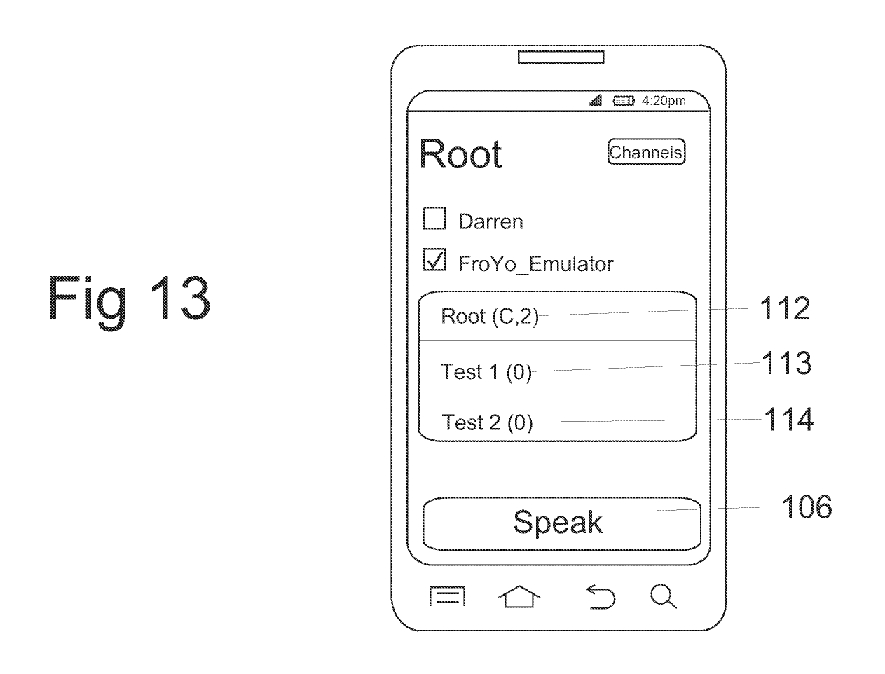

As illustrated in FIG. 12, when the “List” option is selected, various recipient lists are displayed. Any combination of these may be selected. As shown in FIG. 12, the List function may include one or more individuals 102, or one or more lists or groups 104. For example, a “call-to-action” may be sent only to first responders, or it may be sent to first responders and other selected personnel. The recipient database may be local or private, and may be housed on a server, as previously described. When the group option 104 is selected, the various groups are displayed as indicated at 112, 113 and 114 in FIG. 13. Once the recipients are selected, the “Speak” option 106 is selected and the system is activated for sending the message. It should be understood that the “Speak” option includes sending along with the voice message any bundled message components as previously discussed, or specifically, the entire message packet.

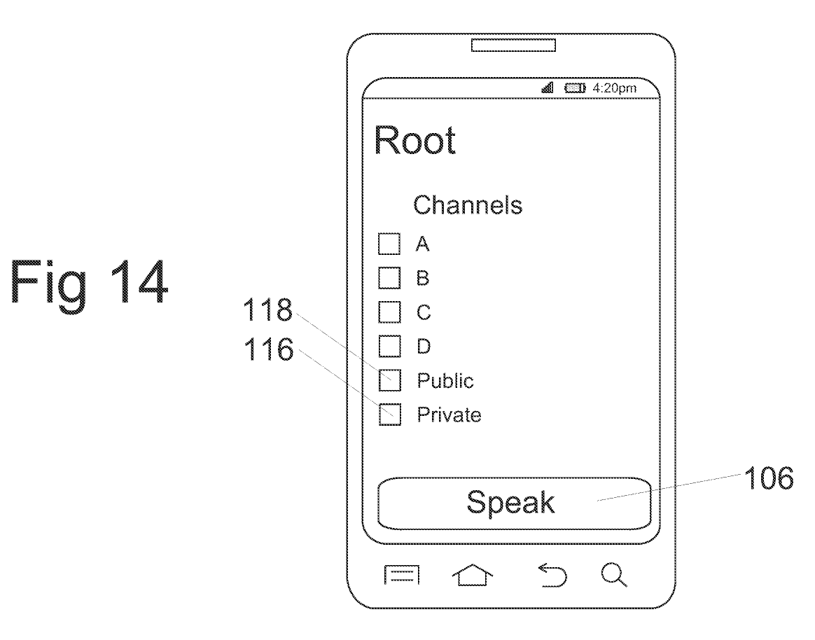

An additional feature is shown in FIG. 14. It is possible to communicate over various channels using the system of the present invention, thereby providing additional flexibility. For example, Channel A may be first responders only, Channel B may be news outlets, and Channel C may be government leaders. Based on the content of the message, the message may be targeted to any combination of these channels. It may also be broadcast over all channels via the Public Channel 116. Where desired, a Private message may be sent by selecting a single recipient or very limited group of recipients as indicated by the Private option 118. In yet another example, the system shall have the capability to combine multiple channels, such as, combining Channel A and Channel C to create Channel D. While combining channels users from Channel B may be added, or opt to join, the new Channel D without adding Channel B to Channel D.

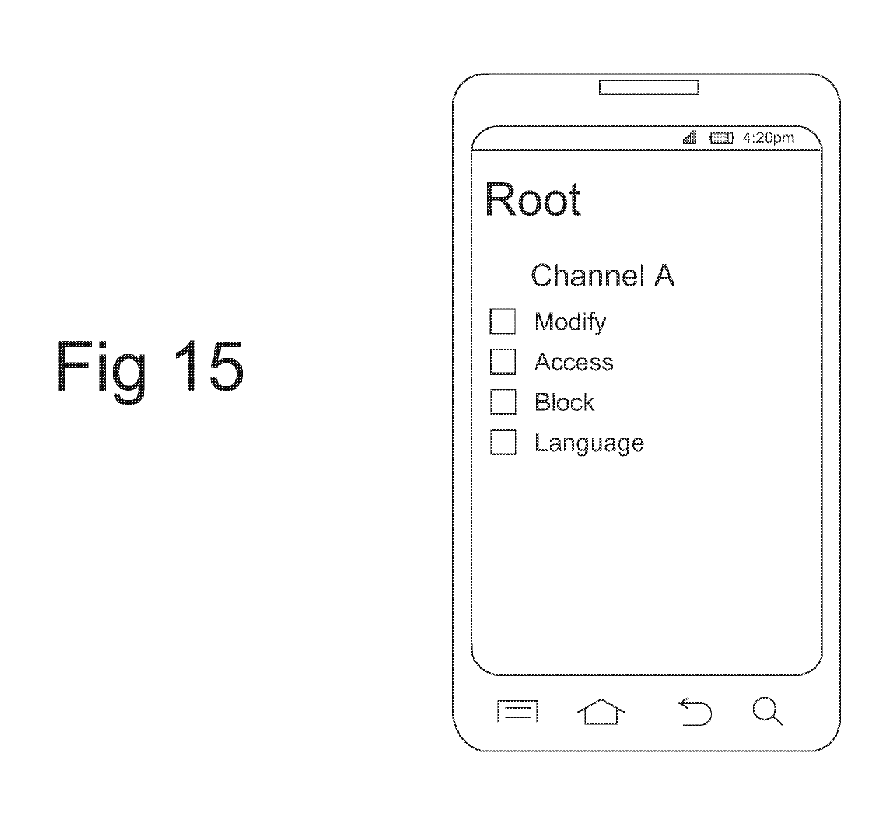

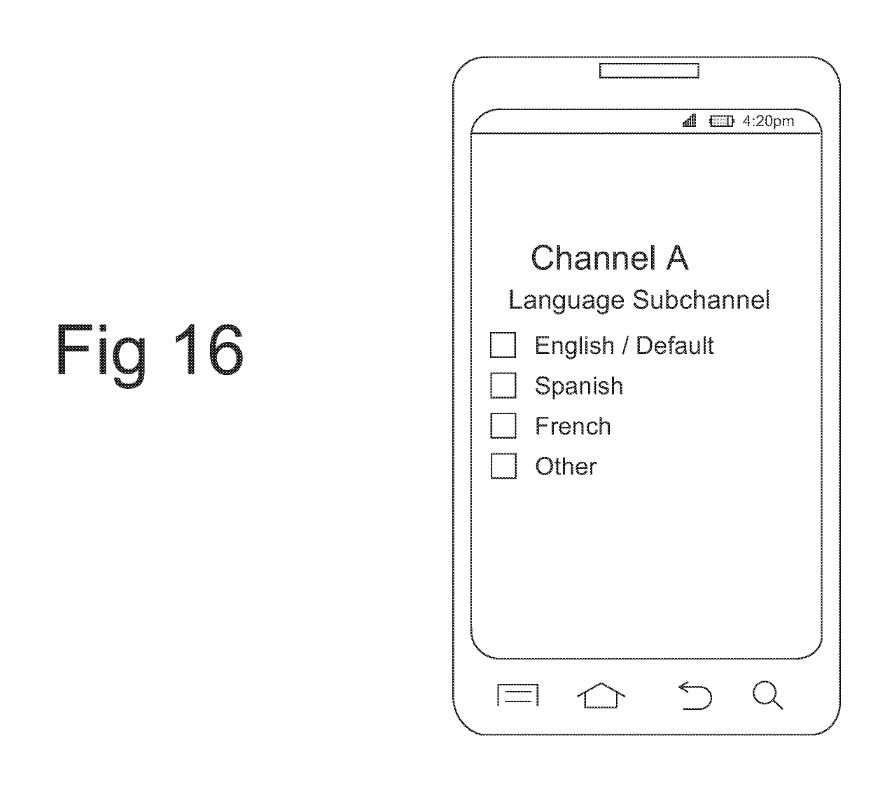

Depending upon authorization level, the sender may modify, control access, or block transmissions on selected channels as indicated in FIG. 15. Also, as indicated in FIG. 15, the recipient or sender may select the language for the message. Since the language translation function will be at the server, in the preferred embodiment, either the sender or the receiver may select the language. As shown in FIG. 15, to control the language, the user selects “Language” for the chosen channel. Then, the screen of FIG. 16 will appear and the user will select the appropriate language for his use as either a sender or a receiver. Where desired a default language may be set. In practice this permits the sender to send the message in his native tongue and the receiver to select it in his native tongue, greatly expanding the applicability of system.

Multiple servers may be added or a selection of server(s) from a group of servers at the option of the sender, as shown in FIG. 17. This may be desired, for example, when it is useful to communicate with different groups on multiple servers, such as, by way of example, a school administrative staff stored on a school system server and a first responder group stored on an emergency response server controlled by a municipality.

While certain features and embodiments to the invention have been described in detail herein, it should be understood that the invention encompasses all modifications and enhancements within the scope and spirit of the appended claims.

1. A digital two-way communication network, comprising:
a. a processor with data storage for containing computer instructions for instructing the processor to perform a series of steps;
b. a server in communication with the processor comprising:
i. a create communication channel module;
ii. a distribute communication channel module;
iii. a communication channel;
c. a database in communication with the processor comprising:
i. user information comprising:
1. user device information;
2. user permissions;
ii. transmitted data;
iii. reporting information;
d. a application for communicating with the processor comprising:
i. a prepare communication channel module;
ii. a distribute communication channel module;
iii. a data transmission module,
whereby the application may communicate with the processor instructing the server to prepare at least one communication channel, and upon receiving the instructions from the processor the server may create a communication channel using the communication channel module, and upon creating the communication channel the server may distribute the communication channel through the processor using the communication channel module, and upon distributing the communication channel the application may transmit data using the data transmission module to the communication channel.

2. The system of claim 1, wherein the communication channel may be encrypted.

3. The system of claim 1, wherein the application has the ability to join two channels.

4. The system of claim 1, wherein the server has the ability to join two or more channels.

5. The system of claim 1, wherein the user device information comprises a unique identification.

6. The system of claim 1, wherein the server may approve a device for communicating with the channel.

7. The system of claim 1, wherein the server may reject a device from communicating with the channel.

8. The system of claim 1, wherein the application may approve a device for communicating with the channel.

9. The system of claim 1, wherein the application may reject a device from communicating with the channel.

10. The system of claim 1, wherein the device can be one of the following, wireless device, wired device, cell phone, television, radio, computer, interactive display, telephone, hardware console, and other similar devices.

11. The system of claim 1, wherein the communications channel may receive audio.

12. The system of claim 1, wherein the communications channel may receive video.

13. The system of claim 1, wherein the communication channel may receive text.

14. The system of claim 1, wherein the communication channel may broadcast audio.

15. The system of claim 1, wherein the communication channel may broadcast video.

16. The system of claim 1, wherein the communication channel may broadcast text.

17. The system of claim 1, wherein the application may be downloaded from the server.

18. The system of claim 1, wherein the application may be pushed from the server to the user device.

19. The system of claim 1, wherein the server may broadcast a call-to-action.

20. The system of claim 19, wherein the call-to-action may transmit a message.

21. The system of claim 19, wherein the call-to-action may transmit a video.

22. The system of claim 19, wherein the call-to-action may transmit an image.

23. The system of claim 1, wherein the database comprises user device information.

24. The system of claim 1, wherein the database comprises reporting information.

25. The system of claim 1, wherein the system may enable a channel based on location.

26. The system of claim 1, wherein the system may enable a channel based on an event.

27. A method for an application for a mobile digital communication device, the method comprising the steps of:
a. Accessing a list of recipients who can send and receive a message;
b. Creating a message;
c. Incorporating the message into a digital data packet;
d. Connecting the device to a digital transmission network;
e. Transmitting the data packet over the digital transmission network to all of the recipients on the list;
f. Automatically activating a return function permitting the recipient to respond to the message.

28. The method of claim 27, wherein the data packet includes any combination of voice, text, graphic, video, still image, mapping and gps data.

29. The method of claim 27, including the step of assigning recipient to dedicated channels, wherein transmission of the data packet is transmitted to a selected assigned channel.

30. The method of claim 27, including the step of converting a voice message text for incorporation in the data packet.

31. The method of claim 27, including step of converting a text message into voice for incorporation in the data packet.

32. The method of claim 27, including the step of translating these messages from a source language to an alternative language.

33. The method of claim 32, wherein the alternative language is controlled by the source device.

34. The method of claim 32, wherein the alternative language is controlled by the receiving device.

35. The method of claim 27, wherein the gps location can be utilized to define a zone within which receiving devices are considered to be in a selected channel.

36. The method of claim 27, including the step of encrypting the data packet before it is transmitted.
